(19) United States
(12) Patent Application Publication
(10) Pub. No.: US 2022/0270094 A1
(43) Pub. Date: Aug. 25, 2022

(54) Autonomous Account Creation for Single Sign-On

(71) Applicant: Bolt Financial, Inc., San Francisco, CA (US)

(72) Inventors: Emily Yeh, San Francisco, CA (US); Nicholas Robert Fiacco, San Francisco, CA (US); Tongchen Zou, San Francisco, CA (US); Melvin Philips, Redwood City, CA (US)

(21) Appl. No.: 17/379,881

(22) Filed: Jul. 19, 2021

Related U.S. Application Data
(60) Provisional application No. 63/153,351, filed on Feb. 24, 2021.

(51) Int. Cl. G06Q 20/40; G06Q 20/36; G06Q 20/12; G06Q 30/06

(52) U.S. Cl. CPC G06Q 20/4014; G06Q 20/3674; G06Q 20/12; G06Q 30/0609

(57) ABSTRACT

In one embodiment, a method includes receiving, by a transaction processing system, a request to access a customer account associated with the transaction processing system. The request includes a user identifier. The method includes determining that the user identifier is associated with an account record for a customer stored in a database associated with the transaction processing system. The method includes verifying authorization to access the customer account associated with the transaction processing system by sending a confirmation code via a communication channel associated with the user identifier. The method includes coordinating with a merchant account platform system to associate the customer account associated with the transaction processing system with a customer account associated with the merchant.

### PRIORITY

This application claims the benefit, under 35 U.S.C. § 119(e), of U.S. Provisional Patent Application No. 63/153,351, filed 24 Feb. 2021, which is incorporated herein by reference.

### TECHNICAL FIELD

This disclosure generally relates to interfaces and interaction flows for managing customer accounts in sales transactions.

### BACKGROUND

Many online purchases are made by customers through independent merchants. In most cases, merchants allow customers to either register for an account with the merchant or to proceed with a purchase as a “guest.” Customers who register for accounts with a merchant often receive benefits, such as expedited re-ordering or subsequent ordering because the merchant can store necessary purchase information or easy access to an order history. Customers who make purchases as a guest must re-enter information such as shipping and payment information for each order. However, customers may prefer not to make additional accounts as they do not wish to be responsible for remembering an additional account name and password for each merchant from which they make purchases. Additionally, customers can be wary of entrusting additional merchants to securely store information such as payment information, shipping addresses, and contact information. This added burden discourages customers from taking advantage of the benefits offered by merchant-specific accounts and increases the friction and computing resources typically necessary to complete each subsequent customer order.

Customer discomfort with creating merchant-specific accounts also creates inefficiencies for merchants. Merchants may struggle to identify customers across purchases, decreasing the ability for the merchant to accurately recommend products related to previous purchases. Merchants also risk losing or reducing sales to customers as a result of customers deciding against making purchases after being asked to re-enter information. Merchants must also allocate additional computational resources to provide for user interfaces and other user experience features to accommodate return customers to re-enter information necessary for a purchase.

### SUMMARY OF PARTICULAR EMBODIMENTS

Embodiments described herein include a single-sign on (SSO) procedure that facilitates users, e.g., customers, creating accounts associated with one or more individual merchants and a transaction processing system. Also described are procedures for users to securely merge existing merchant accounts with a transaction processing system account through the SSO procedure provided by the transaction processing system. Through use of the SSO procedure, customers can confidently use a single login procedure, which may employ multiple types of security features, to easily access merchant-specific account information.

In particular embodiments, a transaction processing system receives a request to access a customer account associated with the transaction processing system. The request may include a user identifier. The transaction processing system may determine that the user identifier is associated with an account record for a customer stored in a database associated with the transaction processing system. The transaction processing system may verify authorization to access the customer account associated with the transaction processing system by sending a confirmation code via a communication channel associated with the user identifier. The transaction processing system may coordinate with a merchant account platform system to associate the customer account associated with the transaction processing system with a customer account associated with the merchant.

The embodiments disclosed above are only examples, and the scope of this disclosure is not limited to them. Particular embodiments may include all, some, or none of the components, elements, features, functions, operations, or steps of the embodiments disclosed above.

### BRIEF DESCRIPTION OF THE DRAWINGS

FIG. 1 illustrates an example process for interacting with a transaction processing system on a website of a merchant.

FIGS. 2A-2J illustrate example interfaces in the interface flow of FIG. 1.

FIG. 3 illustrates an example process for checking out at a merchant website with a transaction processing system.

FIGS. 4A-4J illustrate example interfaces in the interface flow of FIG. 3.

FIG. 5 illustrates a summary of customer groups that may be associated with a customer.

FIGS. 6A-6E illustrate summaries of interfaces shown to a customer.

FIG. 7 illustrates a process used by a platform to create accounts and login users.

FIG. 8 illustrates endpoints for an application programming interface or webserver.

FIG. 9 illustrates an endpoint for an application programming interface or webserver.

FIG. 10 illustrates a schema for platform accounts.

FIG. 11 illustrates physical architecture of a transaction processing system platform.

FIG. 12 illustrates an alternate visualization of the platform.

FIG. 13 illustrates transaction processing system platform connections with third party ecommerce platforms.

FIG. 14 illustrates information flows between the transaction processing system platform and a third party platform.

FIG. 15 illustrates the lifecycle of a purchase order.

FIG. 16 illustrates an example computer system.

### DESCRIPTION OF EXAMPLE EMBODIMENTS

Particular embodiments disclosed herein may be designed to address specific problems or omissions in the current state of the art as described herein. As described herein, particular embodiments include systems and method for providing a single-sign on (SSO) procedure that facilitates users, e.g., customers, creating accounts associated with one or more individual merchants and a transaction processing system. Also described are procedures for users to securely merge existing merchant accounts with a transaction processing system account through the SSO procedure provided by the transaction processing system. In particular embodiments, a transaction processing system receives a request to access a customer account associated with the transaction processing system. The request may include a user identifier. The transaction processing system may determine that the user identifier is associated with an account record for a customer stored in a database associated with the transaction processing system. The transaction processing system may verify authorization to access the customer account associated with the transaction processing system by sending a confirmation code via a communication channel associated with the user identifier. The transaction processing system may coordinate with a merchant account platform system to associate the customer account associated with the transaction processing system with a customer account associated with the merchant. In particular embodiments, the request to access the customer account associated with the transaction processing system is received with a checkout request associated with the merchant. The transaction processing system may retrieve payment information for the customer from the account record stored in the database associated with the transaction processing system. The transaction processing system may place the order on behalf of the customer with the merchant using the retrieved payment information. In particular embodiments, the transaction processing system may cause the retrieved payment information for the customer to be presented in a user interface of a user device associated with the customer. The user interface may also include an interactive element corresponding to consent to place the order. Prior to placing the order on behalf of the customer, the transaction processing system may receive an indication from the user device that the user has selected the interactive element corresponding to consent to place the order.

In particular embodiments, coordinating with the merchant account platform system to associate the customer account associated with the transaction processing system with the customer account associated with the merchant includes a series of additional steps. The transaction processing system may receive, from the merchant account platform system, an indication that the user identifier is not associated with any customer account associated with the merchant. The transaction processing system may provide, to the merchant account platform system, information from the account record for the customer stored in the database associated with the transaction processing system. The merchant account platform system creates the customer account associated with the merchant using the provided information from the account record for the customer. The transaction processing system may receive, from the merchant account platform system, a confirmation that the user identifier has been associated with the customer account associated with the merchant. In other embodiment, the transaction processing system may receive, from the merchant account platform system, an indication that the user identifier is associated with the customer account associated with the merchant. The customer account associated with the merchant is further associated with a second user identifier. The transaction processing system may verify authorization to access the customer account associated with the merchant by sending a confirmation code via a second communication channel associated with the second user identifier. The transaction processing system may receive, from the merchant account platform system, a confirmation that the user identifier has been associated with the customer account associated with the merchant.

In particular embodiments, the confirmation code is a dynamically-generated authentication code. The transaction processing system may verify authorization to access the customer account by causing an account authentication user interface to be presented on a user device associated with the customer, receiving, via the account authentication user interface, a response code, and determining that the dynamically generated authentication code corresponds to the response code. The user identifier may be an email or a phone number. In particular embodiments, the transaction processing system may receive, from the merchant account platform system, a login request to access the customer account associated with the merchant. The transaction processing system may verify authorization to access the customer account associated with the merchant by sending a confirmation code via a communication channel associated with the user identifier associated with the account record for the customer stored in the database associated with the transaction processing system. The transaction processing system may send, to the merchant account platform system, confirmation corresponding to the login request.

In particular embodiments, a transaction processing system may receive a request to access a customer account of a customer associated with a merchant. The request may include a user identifier. The transaction processing system may determine that the user identifier is not associated with an account record for a customer stored in a database associated with the transaction processing system. The transaction processing system may receive consent to create a customer account of the customer associated with the transaction processing system. The transaction processing system may verify authorization to access the customer account associated with the merchant by sending a confirmation code via a communication channel associated with the user identifier. The transaction processing system may store by the transaction processing system the user identifier in association with an account record for the customer in the database associated with the transaction processing system. The account record for the customer may include a reference to the customer account of the customer associated with the merchant. In particular embodiments, the transaction processing system may receive from the customer information to store in the account record for the customer. The information may include biographical information of the customer, payment information of the customer, and shipping preferences of the customer. The transaction processing system may store the received information in the account record for the customer in association with the user identifier and the reference to the customer account of the customer associated with the merchant. Subsequent to storing the user identifier in association with an account record for the customer in the database associated with the transaction processing system, the transaction processing system may receive a checkout request associated with the merchant. The checkout request may include the user identifier. The transaction processing system may retrieve the payment information for the customer from the account record for the customer using the user identifier. The transaction processing system may cause the retrieved payment information for the customer to be presented in a user interface of a user device associated with the customer. The user interface may further include an interactive element corresponding to consent to place the order. Prior to placing the order on behalf of the customer, the transaction processing system may receive an indication from the user device that the user has selected the interactive element corresponding to consent to place the order. In particular embodiments, the request to access the customer account associated with the merchant may be received via a user device of the customer or via a merchant account platform system associated with the merchant.

In particular embodiments, the request to access the customer account associated with the merchant may be received with a checkout request associated with the merchant. The transaction processing system may receive payment information for the customer. The transaction processing system may place the order on behalf of the customer with the merchant using the received payment information. The transaction processing system may update the account record of the customer by storing the payment information for the customer in the account record for the customer stored in the database associated with the transaction processing system. In particular embodiments, the request to access the customer account of the customer associated with the merchant further may include an indication that the user identifier is not associated with any customer account associated with the merchant. The transaction processing system may provide, to a merchant account platform system of the merchant, information from the account record for the customer. The merchant account platform system creates the customer account associated with the merchant using the provided information from the account record for the customer. The transaction processing system may receive, from the merchant account platform system, a confirmation that the user identifier has been associated with the customer account associated with the merchant. The request to access the customer account of the customer associated with the merchant may also include an indication that the user identifier is associated with the customer account associated with the merchant. The transaction processing system may retrieve, from a merchant account platform system of the merchant, information corresponding to the user identifier and the customer account associated with the merchant. The transaction processing system may perform an operation that includes updating the account record for the customer stored in the database associated with the transaction processing system based on the retrieved information corresponding to the user identifier and the customer account associated with the merchant retrieved from the merchant account platform system or providing, to the merchant account platform system, information from the account record for the customer stored in the database associated with the transaction processing system to update the information corresponding to the user identifier and the customer account associated with the merchant. In particular embodiments, the confirmation code is a dynamically-generated authentication code. The transaction processing system may verify authorization to access the customer account associated with the merchant by causing an account authentication user interface to be presented on a user device associated with the customer, receiving a response code via the account authentication user interface, and determining that the dynamically generated authentication code corresponds to the response code. In particular embodiments, the user identifier is an email or phone number.

In particular embodiments, the transaction processing system may receive a request to access a customer account of a customer associated with a merchant. The request may include a user identifier. The transaction processing system may determine that the user identifier is associated with an account record for a customer stored in a database associated with the transaction processing system. The account record for the customer may correspond to an existing customer account associated with the transaction processing system and may reference the customer account associated with the merchant. The transaction processing system may verify authorization to access the customer account associated with the merchant by sending a confirmation code via a communication channel associated with the account record for the customer. The transaction processing system may send, to a merchant account platform system of the merchant, confirmation of authorization to access the customer account of the customer associated with the merchant. In particular embodiments, the request to access the customer account of the customer associated with the merchant may be received with a checkout request associated with the merchant. The transaction processing system may retrieve payment information for the customer from the account record stored in the database associated with the transaction processing system. The transaction processing system may place the order on behalf of the customer with the merchant using the retrieved payment information.

As described herein, customers may, for a variety of reasons, prefer not to make additional accounts for each individual merchant from whom they make purchases. For example, customers may not wish to be responsible for remembering an additional account name and password for each merchant. Customers may only anticipate making a single purchase, eliminating some of the perceived benefits of creating an account. Customers may not desire a merchant to store sensitive information about them and their financial accounts such as in the event of a data breach. Concerns such as these discourage customers from taking advantage of the benefits offered by merchant-specific accounts and increases the friction and computing resources typically necessary to complete each subsequent customer order.

Customer discomfort or disinterest with creating merchant-specific accounts also creates inefficiencies for merchants. Merchants may struggle to identify customers across purchases, decreasing the ability for the merchant to accurately recommend products related to previous purchases. Merchants also risk losing or reducing sales to customers by customers deciding against making purchases after being asked to re-enter information. Merchants must further allocate additional computational resources to provide for user interfaces and other user experience features to accommodate return customers to re-enter information necessary for a purchase as opposed to retrieving information for existing customers.

The single sign-on procedure described herein improves on previous systems for managing customer accounts, resulting in material and measurable improvements in computing systems operating account management systems, especially for ecommerce providers. As an example, using the techniques described herein, a transaction processing system can reduce the number of user interactions required to sign into both a universal account (e.g., created with the transaction processing system) and individual merchant account while employing state of the art security procedures. The single transaction processing system can instantly upgrade and harden its security for account login and management simultaneously, which results in improved account security for participating merchants and their customers. This can all be done without requiring merchants to contribute additional computational, network, or personnel resources to implement new security features. Furthermore, using the techniques described herein, the SSO procedure employed by the transaction processing system can increase the rate of participation of customers in merchant account programs, reducing the number of “guest” purchases. This allows merchants to gather more relevant information about their customers and potentially allow merchants to provide more tailored and relevant information, product recommendations, and experiences to customers, all without increasing the burden on customers or merchants when signing up for an account.

This effect is amplified because once a user, e.g., a customer, creates a universal account with the transaction processing system, they can quickly and easily create subsequent merchant accounts with participating merchants. On customer request, the transaction processing system can provide necessary information to the merchant to create an account. The new account can be secured using state-of-the-art security provided by the transaction processing system, with access to the merchant account being provided through backend, business-to-business type connections not exposed to the public. The customer merely logs into their account with the transaction processing system as usual without sharing additional information directly with the merchant. This reduces the risks attendant with creating additional accounts with a merchant platform the user may not necessarily be familiar with. For example, a customer may be wary of sharing sensitive information, such as payment information, contact information, shipping addresses, etc., with additional merchants and further entrusting those merchants to securely store the information. The customer may justify failure to create an account with a merchant based on desiring to avoid the merchant storing the information and potentially exposing that information (e.g., during a data breach). Additionally, the transaction processing system can enforce requirements of participating merchants to improve their security practices in order to take advantage of the benefits of the SSO procedure by, for example, dictating minimum amounts or types of information that can be collected and/or stored.

As referred to herein, the “Bolt Platform” (also referred to as simply “Bolt”) represents a particular embodiment of the transaction processing system supporting a single-sign on procedure as described herein. Using previous approaches, customers manage merchant website accounts separately from their transaction processing system account. This is a fragmented experience for the customer, and prevents the transaction processing system from integrating with features tied to a merchant account (e.g., a platform account). Such features can include, by way of example and not limitation, loyalty programs, expedited order retrieval and re-ordering, pre-population of checkout windows with relevant information, one-click ordering using stored preferences, self-service returns and other identity-based experiences (e.g., discounts assigned to individual accounts and/or groups of accounts based on common features), merchant wishlists, cross-merchant wishlists (e.g., associated with a user account), cashback programs, referral programs and other related features. To solve this problem, this disclosure contemplates a SSO to power authentication for native platform accounts. This encompasses both logging in and registering new merchant accounts through the transaction processing system, either on checkout or via a sign up button and migration of existing accounts into the transaction processing system. The SSO can be considered a mechanism to facilitate the creation and management of multi-independent customer accounts with a variety of merchants and merchant groups.

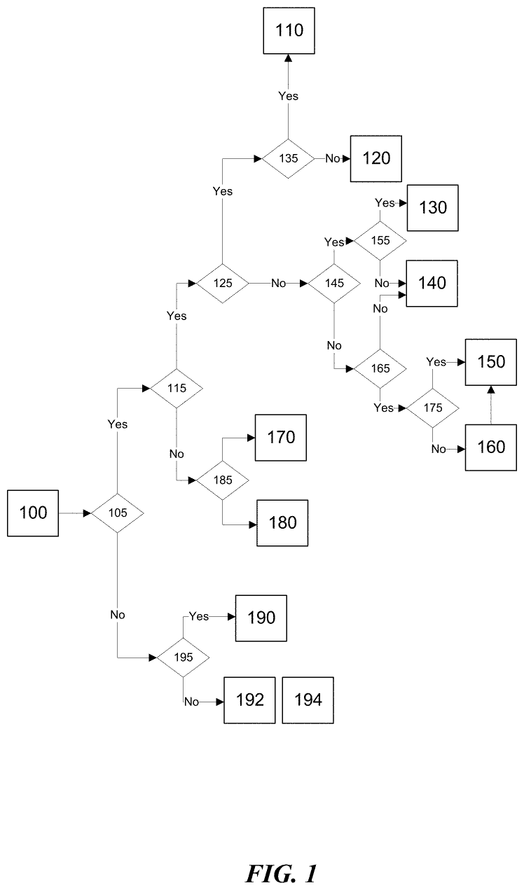

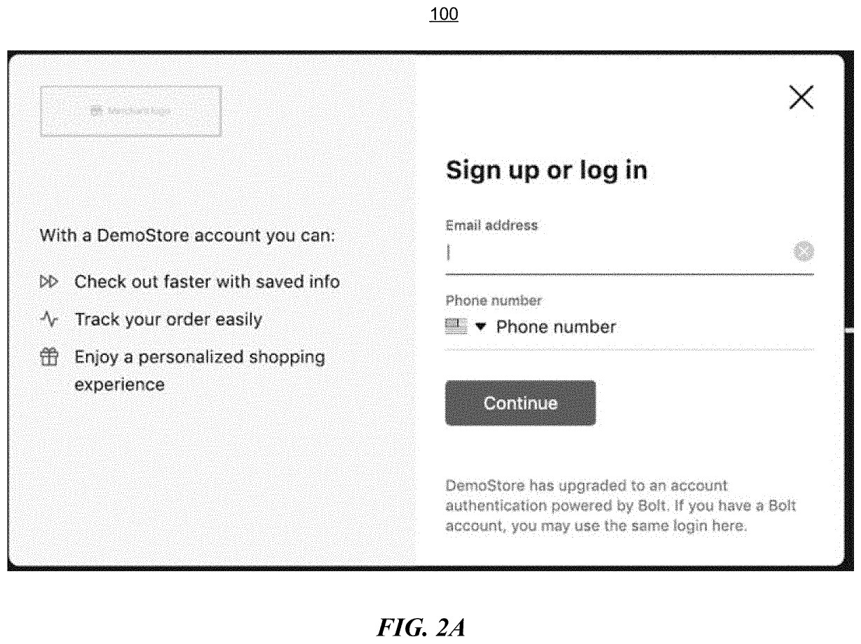

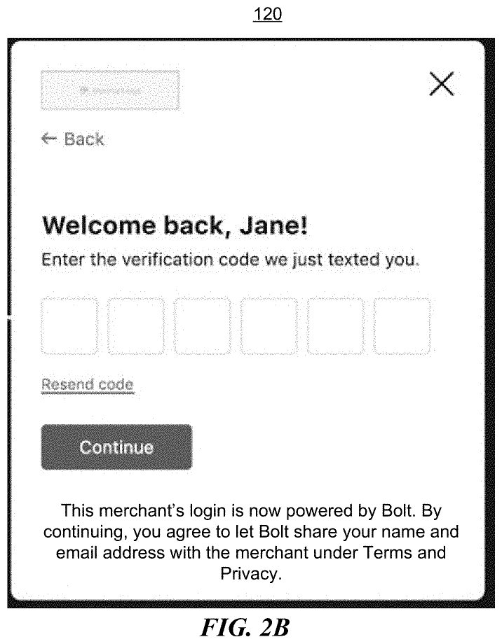

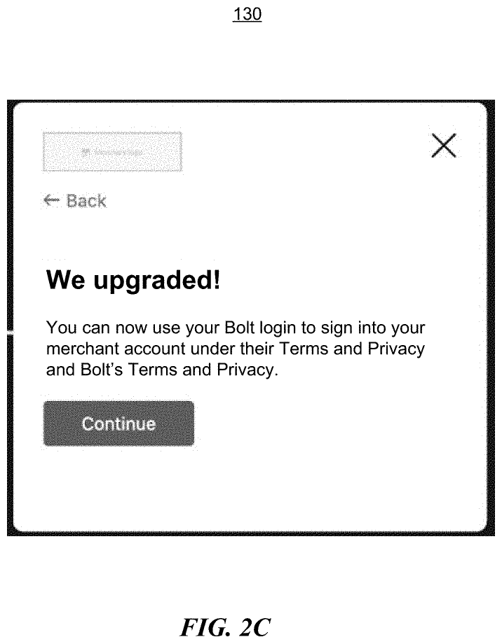

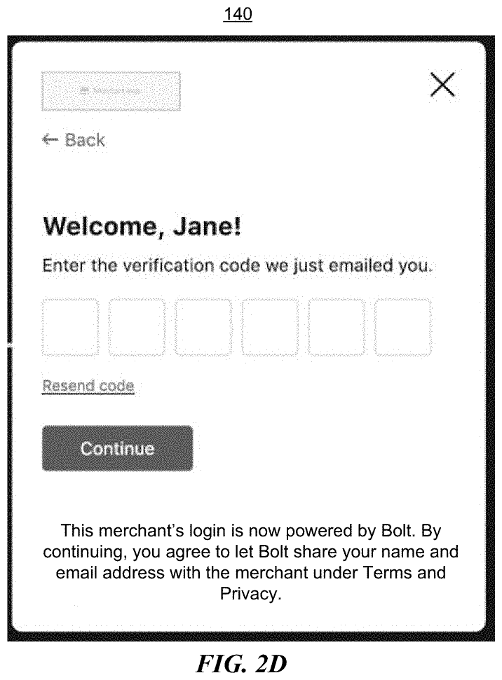

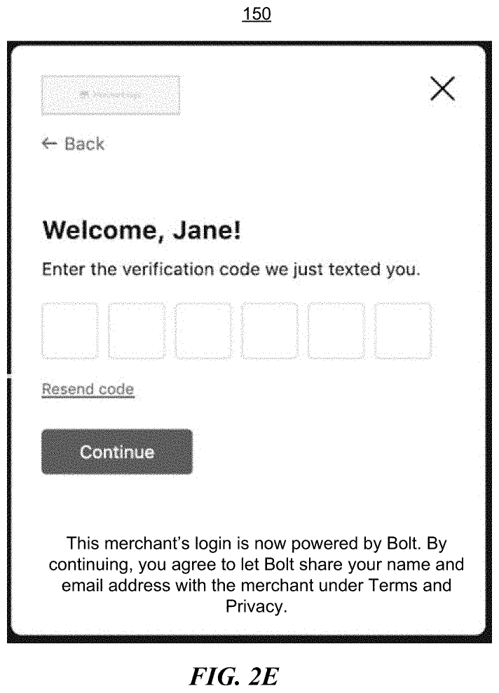

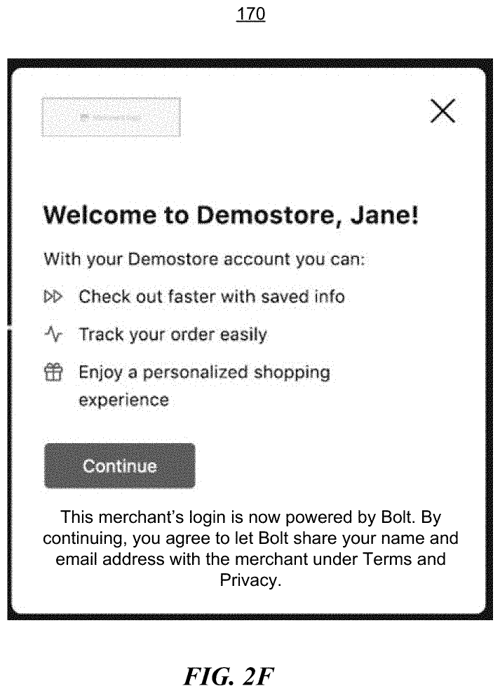

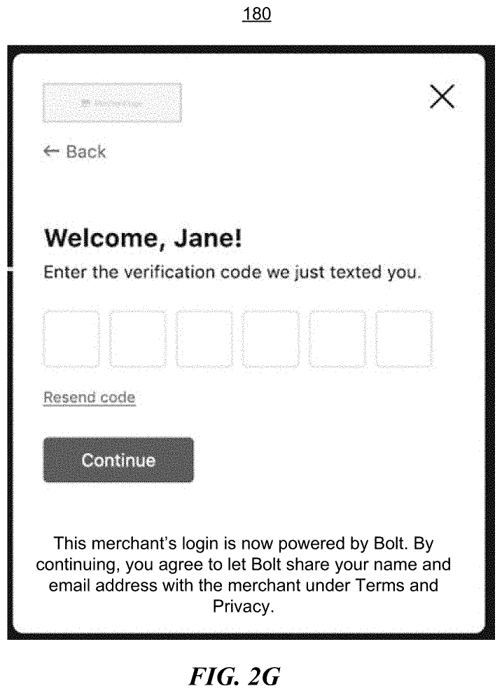

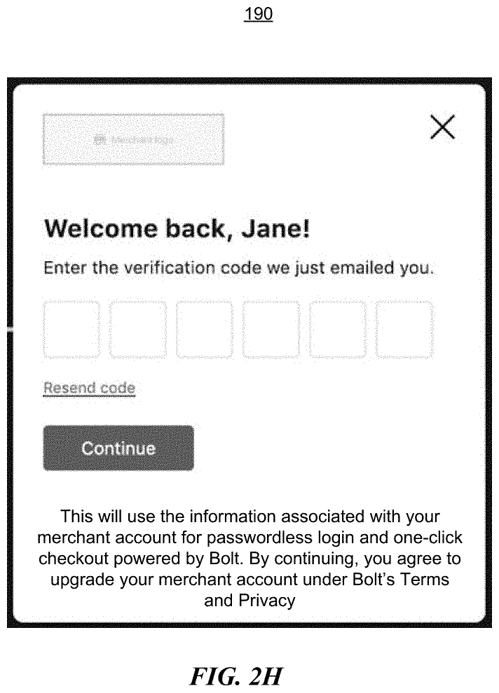

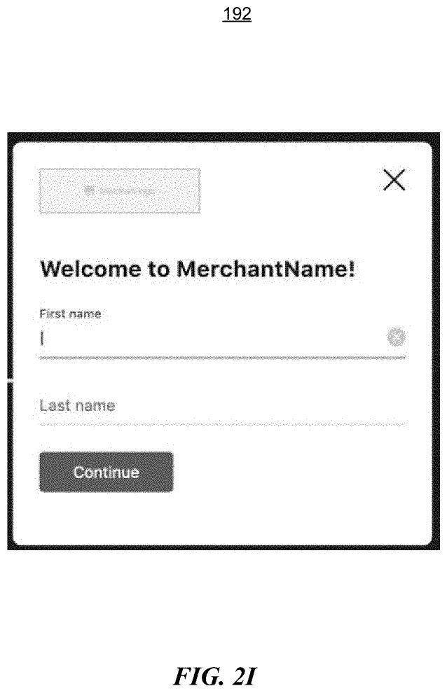

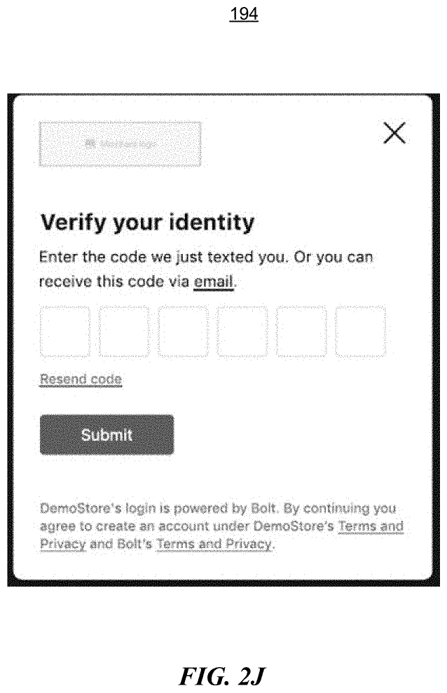

Particular embodiments disclosed herein may be implemented using one or more example processes. A first example procedure is described below with reference to FIG. 1 which illustrates a process for a customer interacting with the transaction processing system on a website of the merchant. FIGS. 2A-2J illustrate example user interfaces corresponding to the flow of the process of FIG. 1. The process begins at step 100, illustrated in FIG. 2A. Step 100 includes a prompt for the customer to log into a merchant website. The customer enters an email address and/or phone number to continue. The system determines at step 105 whether the entered identifier is associated with a transaction processing system account. If yes, the process continues to step 115, where the system determines if the customer has a merchant account based on the entered identifier. If yes, the process continues to step 125 where the system determines if the merchant account and transaction processing system accounts are already linked. If yes, the process continues to step 135, where the system determines if the associated customer is already logged into the transaction processing system account. If yes, the system proceeds to step 110, where no prompt or further input is needed and the customer is automatically logged in. If no, the system proceeds to step 120, illustrated in FIG. 2B. Step 120 includes a prompt for a customer to enter a verification code. The verification code may be sent to the customer via a SMS message using the phone number on record for the customer. The prompt in step 120 correlates to when the customer has both a transaction processing system account and a merchant account.

Returning to step 125, if the transaction processing system account and merchant account are not already linked, the process advances to step 145, where the system determines if the customer is already logged into the transaction processing system. If yes, the process advances to step 155, where the system determines if the entered identifier (e.g., email address) is verified. If yes, the process advances to step 130, illustrated in FIG. 2C. Step 130 includes a prompt alerting the customer that they can log into their merchant account using their transaction processing system account. If, at step 155, the system determines that the entered identifier is not verified, the process advances to step 140, illustrated in FIG. 2D. Step 140 includes a prompt requesting the customer to verify their email address by entering a verification code or linking link sent to the customer email address.

Returning to step 145, if the system determines that the customer is not logged into the transaction processing system, the process advances to step 165, where the system determines if the entered identifier is verified. If yes, the system advances again to step 140. If no, the system advances to step 175, where the system if the phone number entered at step 100 matches the phone number already on record with the email entered at step 100. If yes, the system advances to step 150, illustrated in FIG. 2E. Step 150 includes a prompt requesting the customer to verify their phone number by entering a code sent to the customer via the phone number. If no, the system advances to step 160, illustrated in FIG. 2F. Step 160 includes a prompt requesting the customer to enter a phone number to use for their transaction processing system account. The system sends a message to the customer via the entered phone number and the process advances to step 150.

Returning to step 115, if the system determines that the customer does not have a merchant account based on the identifiers entered at step 100, the system advances to step 185 where the system determines if the customer is currently logged into the transaction processing system. If yes, the process advances to step 170, illustrated in FIG. 2F. Step 170 includes a prompt informing the customer that they can create a merchant account and may demonstrate the benefits of creating a merchant account. If the determination at step 185 is no, the process advances to step 180, illustrated in FIG. 2G. Step 180 includes a prompt for the customer to enter a verification code sent to the phone number entered at step 100.

Returning to step 105, if the system determines that the entered identifier is not associated with a transaction processing system account, the system advances to step 195, where the system determines if the customer has a merchant account based on the entered identifier. If yes, the system advances to step 190, illustrated in FIG. 2H. At step 190, the system sends the customer a verification code using the identifier associated with the merchant and requests the customer to verify and log into the merchant account using the verification code. If, at step 195, the system determines that the customer does not have a merchant account, the system advances to step 192 illustrated in FIG. 2I. At step 192, the system requests the customer to enter information necessary to establish the merchant account, such as biographical information like the customer's name. The system then advances to step 194, illustrated in FIG. 2J. At step 194, the system requests the customer to log into the merchant account by verifying access to the one or more of the identifiers entered at step 100.

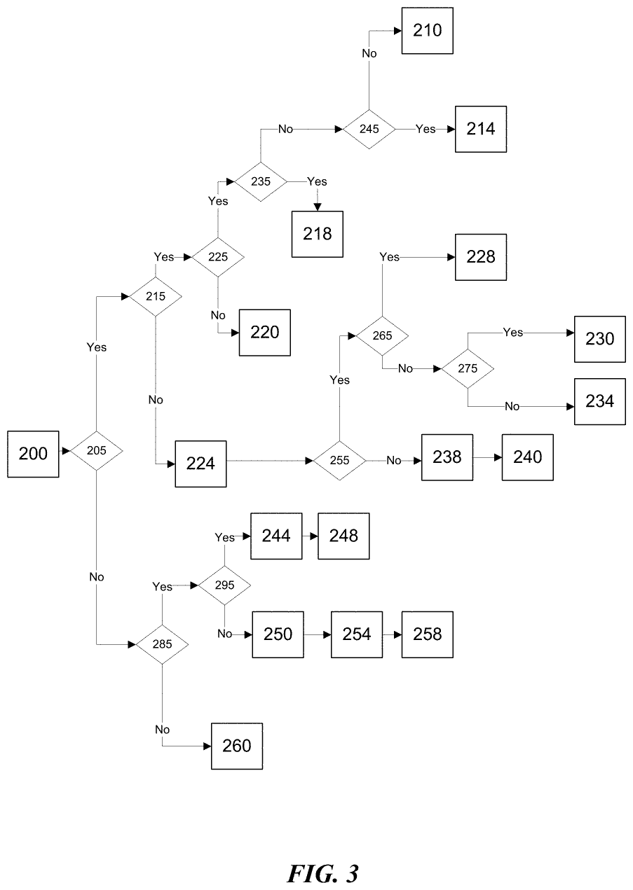

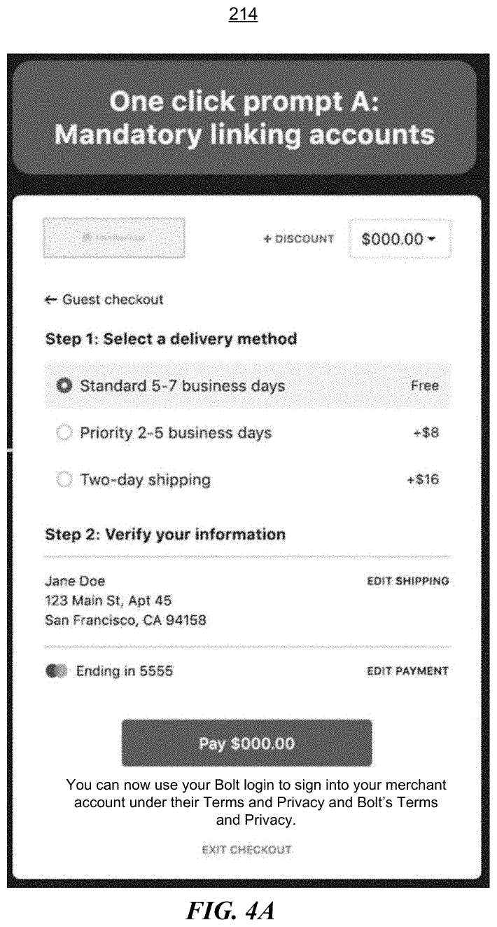

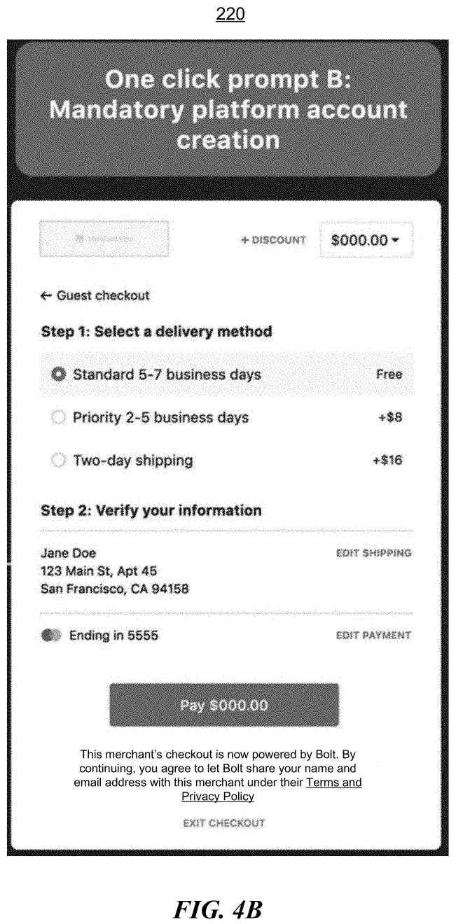

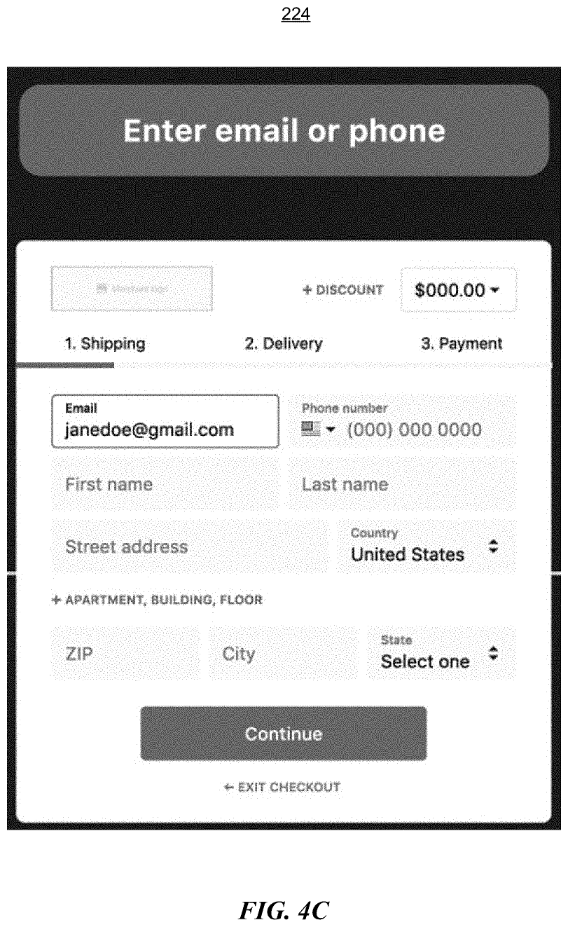

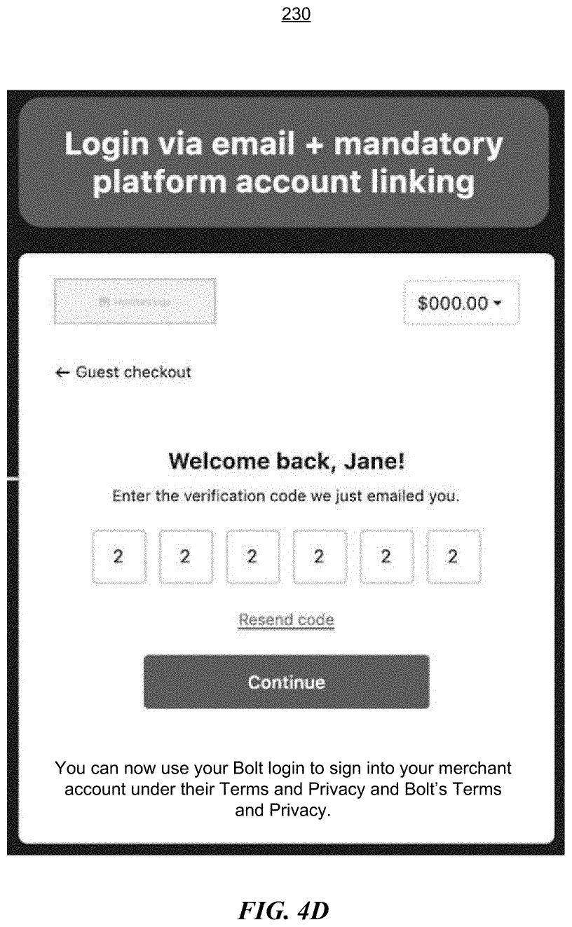

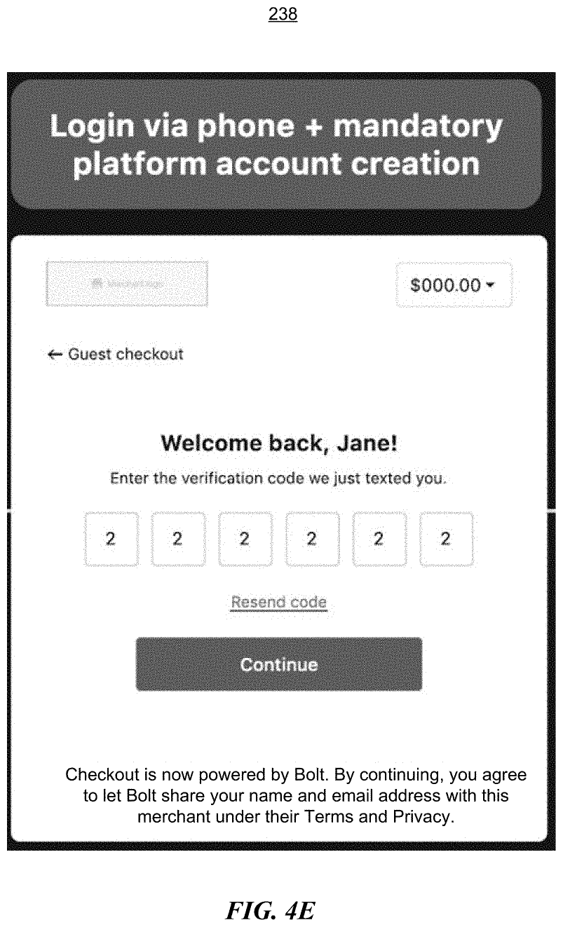

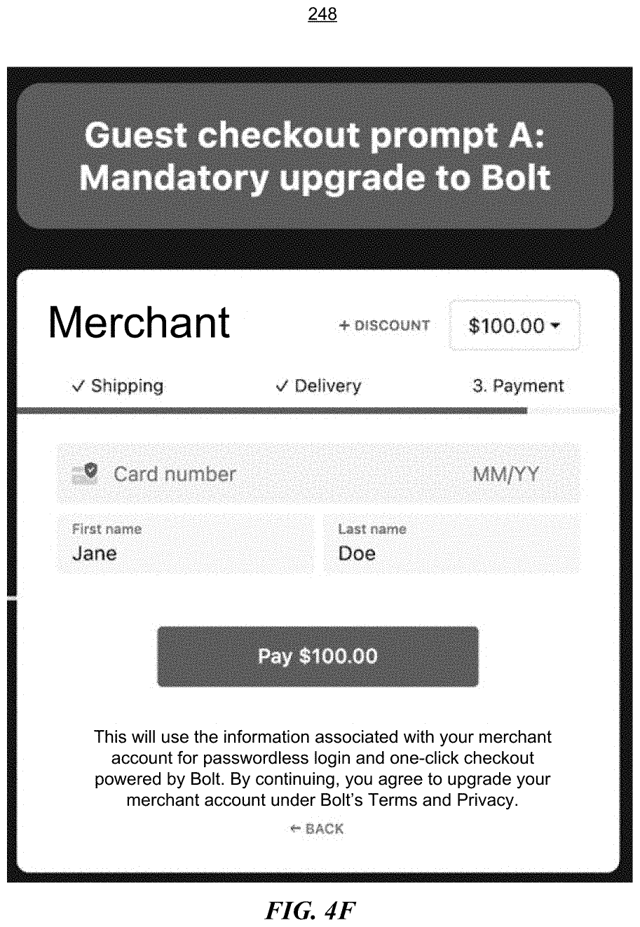

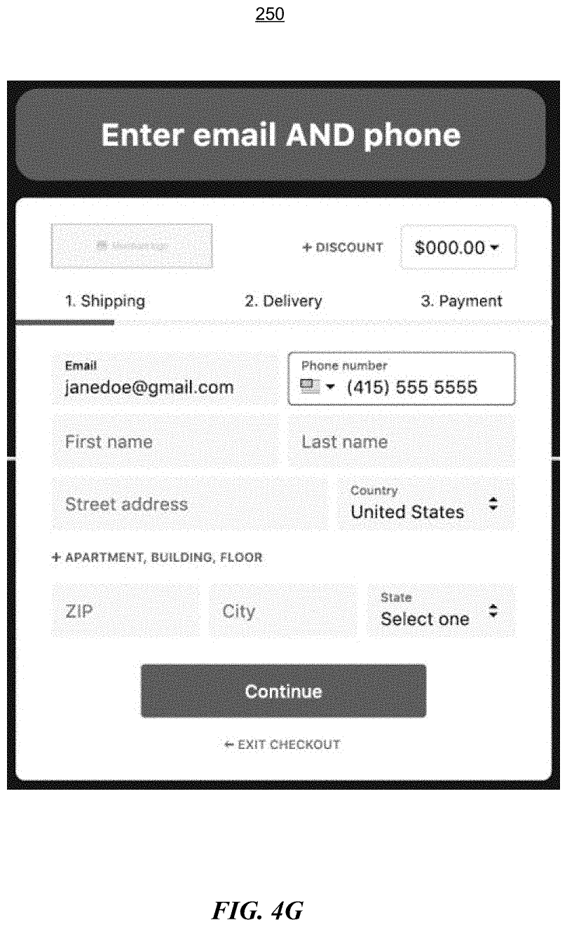

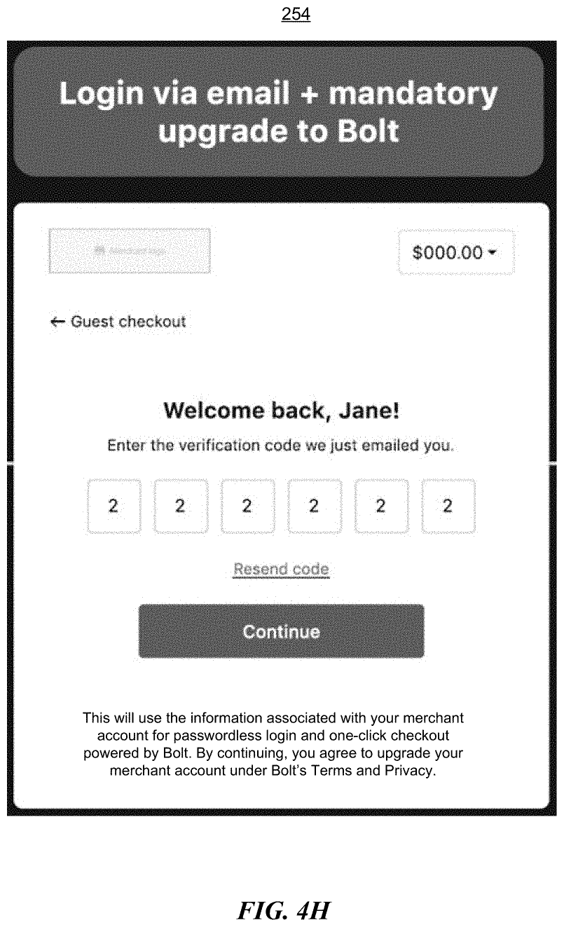

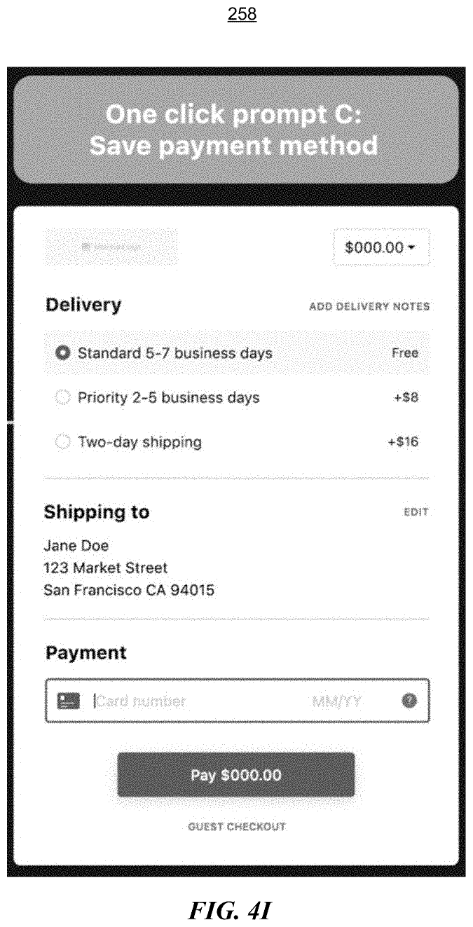

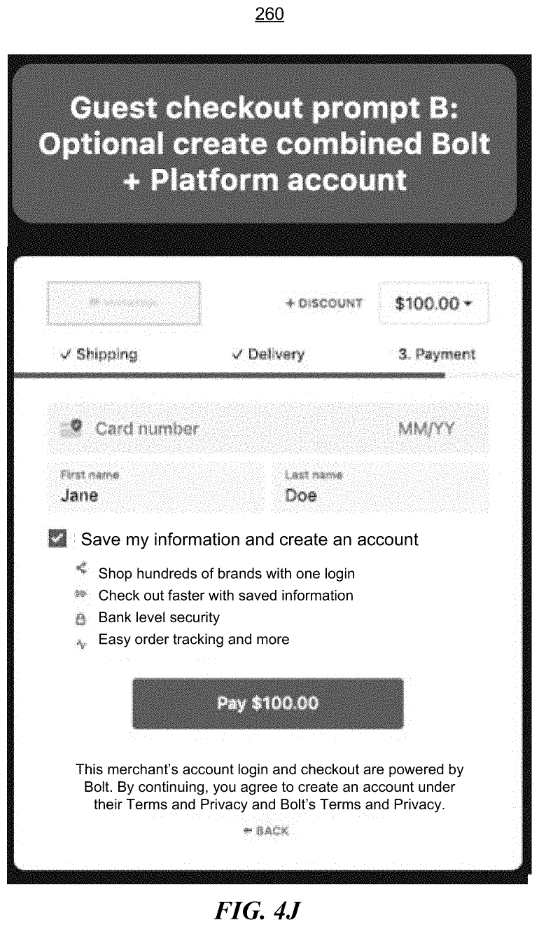

A second example procedure is described below with reference to FIG. 3 which illustrates a process for a customer checking out at a merchant website with the transaction processing system on a website of the merchant. FIGS. 4A-4I illustrate example user interfaces corresponding to the flow of the process of FIG. 3. The process begins at step 200, where the customer enters a checkout procedure at the merchant website or application. The process advances to step 205, where the system determines if the customer has an account with the transaction processing system based on identifiers entered before or during step 200. If yes, the system advances to step 215, where the system determines if the customer is logged into the transaction processing system. If yes, the system advances to step 225, where the system determines if the customer's identifiers (e.g., email address) are associated with a merchant account. If yes, the system advances to step 235, where the system determines if the merchant account and transaction processing system accounts are already linked. If yes, the system advances to step 218, where the system confirms and processes the transaction proposed during step 200. If no, the system advances to step 245, where the system determines if the email address associated with the transaction processing system account is verified. If yes, the system advances to step 214, illustrated in FIG. 4A, where the system confirms and processes the transaction proposed during step 200. For example, the system displays shipping options, address information, and the selected payment method. If no, the system advances to step 210, where the customer is provided the opportunity to merge and confirm the merchant and transaction processing system accounts. Returning to step 225, if the system determines that the customer's identifiers are not associated with a merchant account, the process advances to step 220, illustrated in FIG. 4B. In step 220, the system provides a checkout modal to the customer, allowing the customer to enter and confirm shipping and payment details. In particular embodiments, the system may retrieve information such as a default payment or shipping terms from the merchant that are already associated with the email address of the merchant.

Returning to step 215, if the system determines that the customer is not logged into the transaction processing system, the system advances to step 224, illustrated in FIG. 4C. At step 224, the customer is requested to enter detailed information for the customer, such as a shipping address and phone number. Note that the email address of the customer can be automatically entered at step 224 because it has been provided already, such as in step 200. The process then advances to step 255, where the system determines if the customer has an account with the merchant based on the entered information. If yes, the system advances to step 265, where the system determines if the customer's merchant account is linked with the customer's transaction processing system account. If yes, the process advances to step 228, where the customer is logged into their account. If no, the process advances to step 275, where the system determines if the email address associated with the transaction processing system is verified. If yes, the system advances to step 230, illustrated in FIG. 4D. At step 230, the customer is requested to enter a verification code that has been sent to the email address of the customer. If not, the system advances to step 234, where the customer is requested to log and/or merge their accounts.

Returning to step 255, if the system determines that the customer does not have an account with the merchant, the system advances to step 238, illustrated in FIG. 4E. In step 238, the customer is requested to create a merchant account and verify their phone number by entering an verification code that has been texted to the phone number entered in step 224. On a successful prompt, the customer is provided the option to checkout using default terms. Returning to step 205, if the system determines that the customer does not have an account with the transaction processing system based on identifiers entered before or during step 200, the system advances to step 285, where the system determines if the customer has an account with the merchant. If yes, the process advances to step 295, where the system determines if the customer is logged into their merchant account. If yes, the system advances to step 244, where the customer proceeds with a guest checkout with information prefilled with information from their merchant account. The system then advances to step 248, illustrated in FIG. 4F, where the customer is prompted to complete the checkout and migrate their account to the transaction processing system. Returning to step 295, if the system determines that the customer is not logged into their merchant account, the system advances to step 250, illustrated in FIG. 4G. At step 250, the customer is prompted to enter multiple identifiers (e.g., phone and email address). The system sends a verification code to the customer via the entered email address. The process advances to step 254, illustrated in FIG. 4H, where the customer is requested to enter the verification code. Entering the verification code merges the merchant account and creates a transaction processing system account for the customer. The system advances to step 258, illustrated in FIG. 4I, where the customer is requested to enter and save shipping and payment information.

Returning to step 285, if the system determines that the customer does not have an account with the merchant, the system advances to step 260, illustrated in FIG. 4J. At step 260, the customer is prompted to complete a guest checkout and is provided the option to create a combined/merged transaction processing system account and a merchant account.

Particular embodiments may repeat one or more steps of the example process(es), where appropriate. Although this disclosure describes and illustrates particular steps of the example process(es) as occurring in a particular order, this disclosure contemplates any suitable steps of the example process(es) occurring in any suitable order. Moreover, although this disclosure describes and illustrates an example process, this disclosure contemplates any suitable process including any suitable steps, which may include all, some, or none of the steps of the example process(es), where appropriate. Furthermore, although this disclosure describes and illustrates particular components, devices, or systems carrying out particular steps of the example process(es), this disclosure contemplates any suitable combination of any suitable components, devices, or systems carrying out any suitable steps of the example process(es).

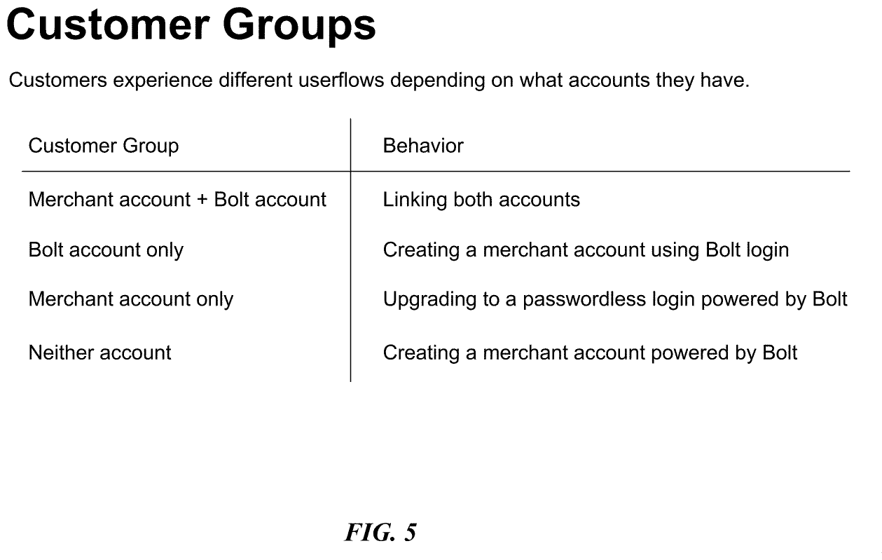

FIG. 5 illustrates an overview or summary of the customer groups that may be associated with a customer based on what accounts they have with, for example, the transaction processing system and/or a merchant affiliated with the SSO procedure.

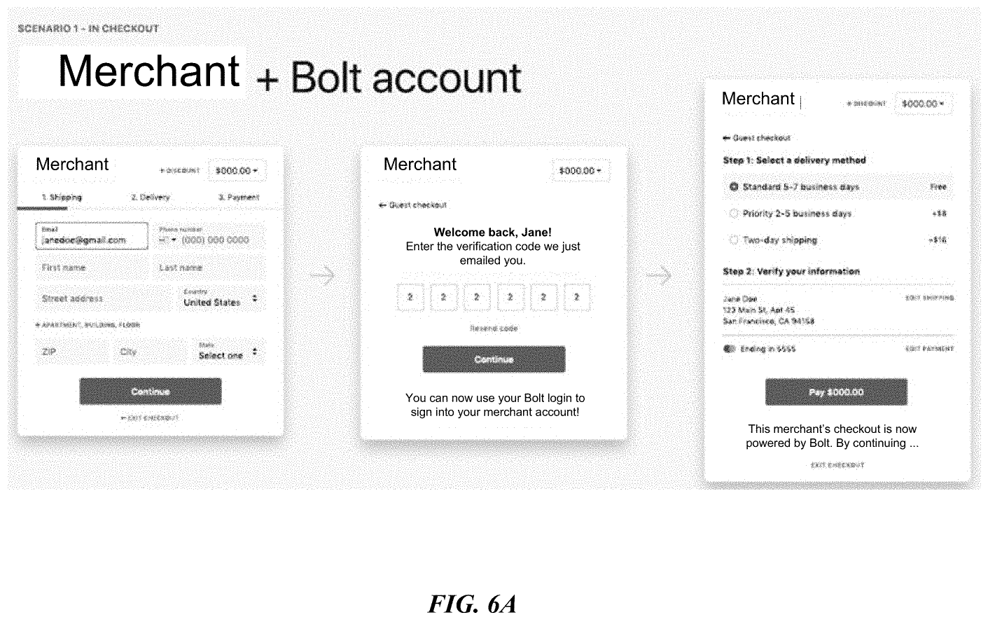

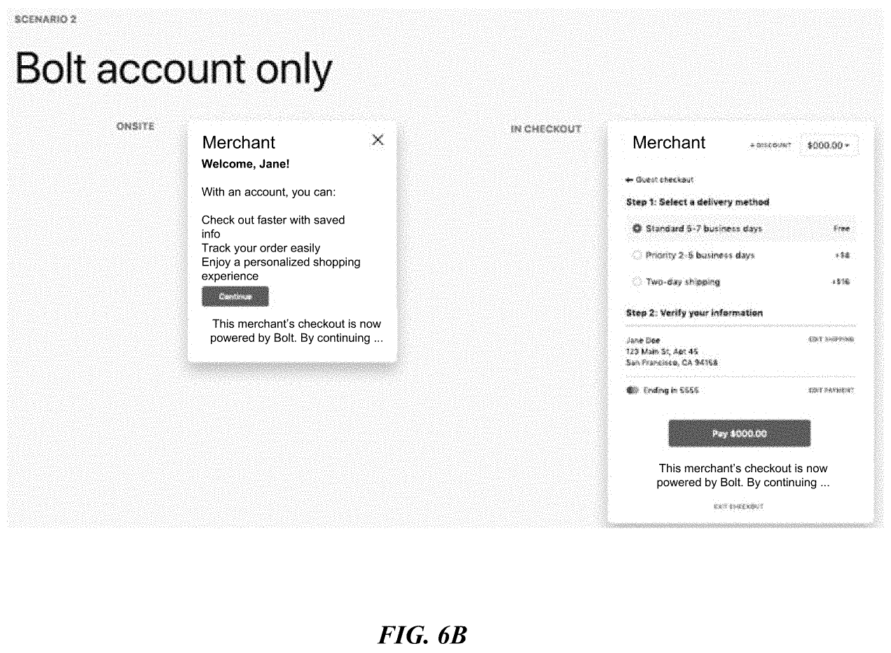

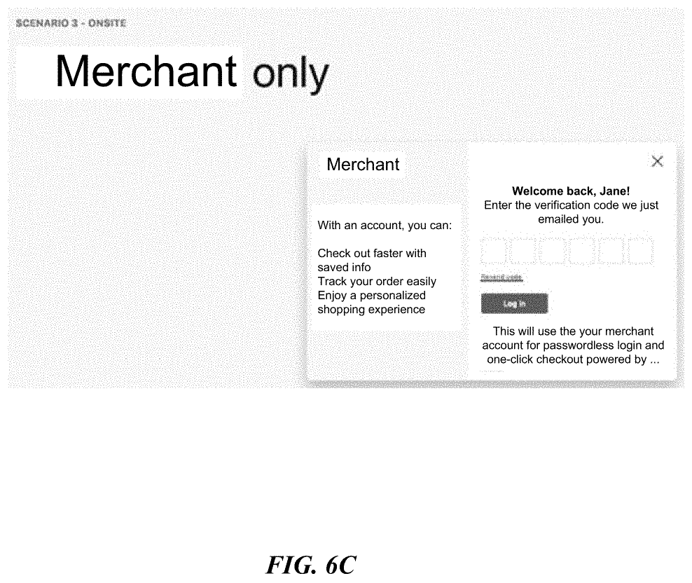

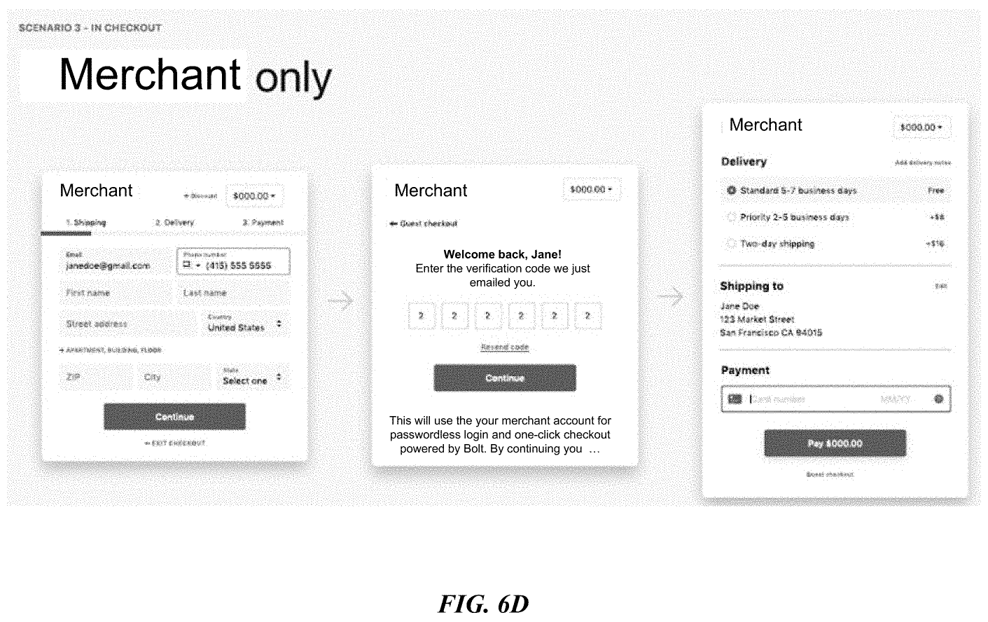

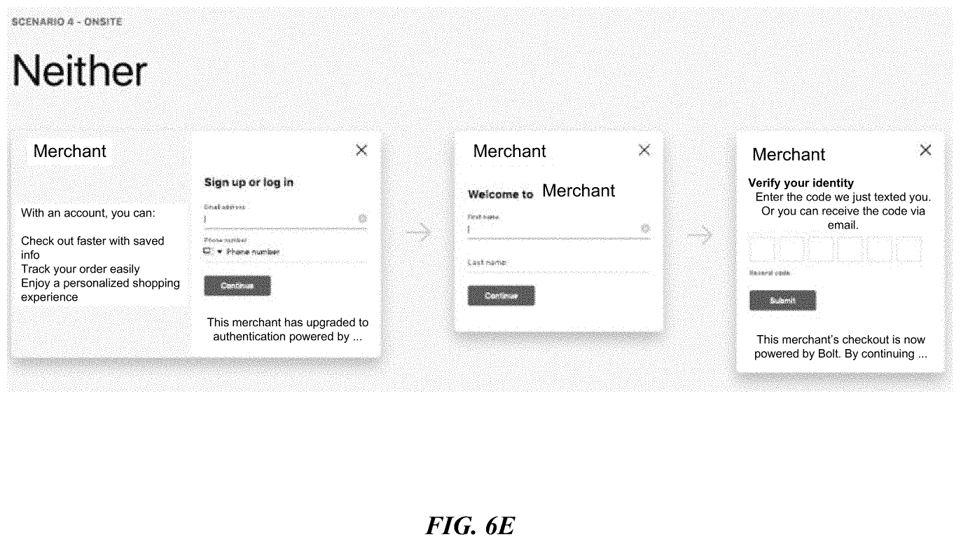

FIG. 6A illustrates a summary of the screens shown to the customer during a checkout in which the customer has a merchant account and transaction processing system account.

FIG. 6B illustrates a summary of the screens shown to the customer during a checkout in which the customer has only a transaction processing system account.

FIGS. 6C-6D illustrates a summary of the screens shown to the customer during a checkout in which the customer has only a merchant account.

FIG. 6E illustrates a summary of the screen shown to the customer during a checkout in which the customer has neither account.

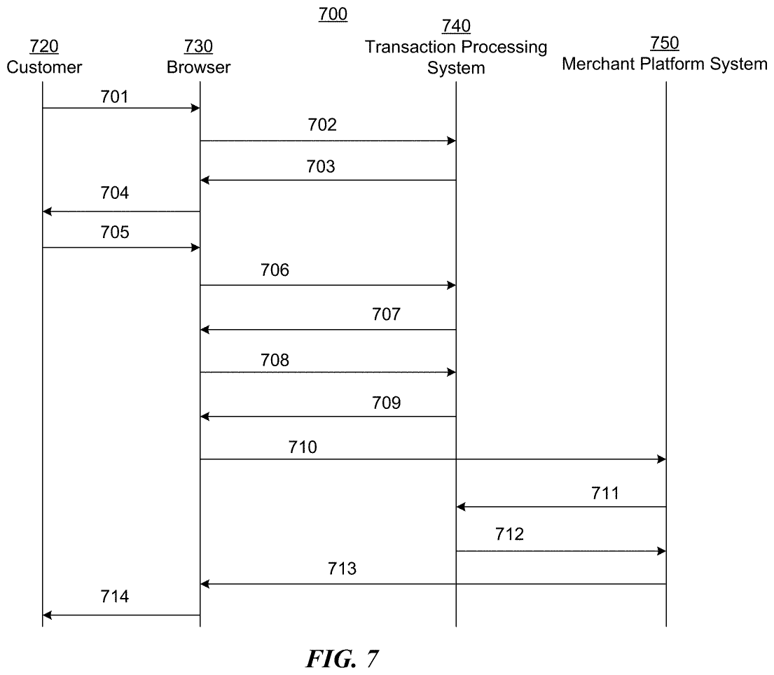

Particular embodiments may use an implementation of OpenID Connect to allow the merchant platform to request information (user ID) about authenticated transaction processing system users. This will be used by the merchant platform to create accounts and login users in their own system. An overview of the entire process 700 is illustrated in FIG. 7. At 701, a customer 720 clicks a login button, which may be presented in a user interface on a user device of the user. A browser 730 may receive a notification of the customer 720 clicking the login button. At 702, the browser 730 redirects to a specified address or endpoint associated with the login authorization procedure. (e.g., https://tps.com/oauth/authorize/). At 703, the transaction processing system 740 receives the request for the login and authorization endpoint and directs the browser 720 to a login page associated with the transaction processing system 740. The login page may be or include one or more of the interfaces discussed herein. At 704, the browser 720 causes a login user interface to be displayed on a user device of the customer 720.

At 705, the customer 720 enters their login credentials (as described herein) into the login user interface presented by the user device of the customer 720. At 706, the browser 730 provides the login credentials to the transaction processing system 740 with a request to initialize the login procedure. Upon receiving the request, at 707, the transaction processing system 740 sets a login session with the browser 730 to establish and validate the login request. At 708, the browser 730 then redirects again to the specified address or endpoint associated with the login authorization procedure. In some embodiments, the 730 provides the received login credentials and/or session information. The transaction processing system 740 then determines whether the credentials are valid for the account of the customer. In response, based on the provided credentials, the transaction processing system recognizes the credentials as being associated with an account associated with a merchant platform system 750 (e.g., an account platform of a merchant or other associated with a merchant). In particular embodiments, the login can be provided as a passwordless or one-time password (OTP) system in which the transaction processing system 740, simultaneous with the login page being presented, sends a password to the user device of the customer 720 using a communication channel associated with a customer's account. The communication channel can be based on the type of user identifiers stored with the user account (e.g., an email address can be associated with an email communication channel, a phone number can be associated with a short message service (SMS) communication channel or automated voice call communication channel). The customer 720 enters the received password into the login page and the transaction processing system 740 compares the provided password with the received password to determine a correspondence before allowing the login to proceed.

The transaction processing system 740 then provides a redirect request (e.g., a redirection URL) to the browser 730 instructing the browser to redirect to the login endpoint associated with the merchant platform system 750. The redirect request can include a code, token, or other signal that can be used by the merchant platform system 750 to expedite the login procedure and attribute a subsequent login request at the merchant platform system 750 with the validated login at the transaction processing system. At 710, the browser 730 processes the redirect request, e.g., a redirection URL, and connects to the merchant platform system 750 using information provided in the redirect request. The browser 730 can also provide the code received from the transaction processing system 740. At 711, the merchant platform system 750 calls the endpoint of the transaction processing system 740 associated with the login authorization procedure. The call can include the code received by the merchant platform system 750 from the browser 730 at 709. The transaction processing system 740 confirms that the code is valid and provides, at 712, an identity token or other signifier of the customer account with the merchant platform system 750 associated with the transaction processing system 740 account into which the customer 720 has successfully logged in. The merchant platform system 750 can verify the platform account for the customer using the identity token. Upon determining that the token corresponds with the appropriate account of the customer 720 with the merchant platform system 750, the merchant platform system 750 can send another redirect back to the browser 730 associated with an account management page associated with the platform account of the customer. The account management page can include other pages that require authentication to access. At 714, the browser 730 can cause the platform account page (or other appropriate page) to be displayed to the customer 720, e.g., on a user device of the customer.

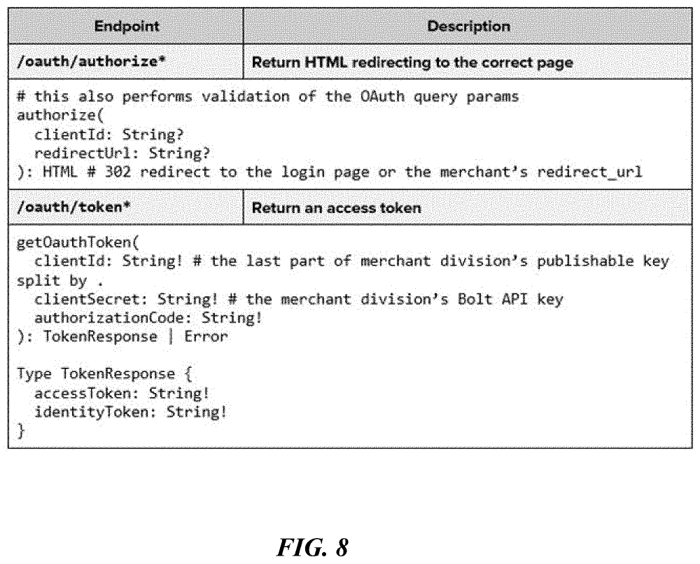

OAuth authorization and resource server protocols may be implemented to support this account creation procedure. These include endpoints for an API or webserver that may be called by merchants. Endpoints compatible with this procedure are summarized in FIG. 8, although it will be understood that extensions and modifications may be developed without deviating from the form of that envisioned in this disclosure. The identity token will be a JSON web token (“JWT”) which the receiving server (e.g., merchant platform system 750) can verify using a public key associated with the transaction processing system. Once verified, it can be decoded. As an example only, and not by way of limitation, the identity token can include the following contents:

```
identityToken: {
  sub: string
  first_name: string
  last_name: string
  email: string
  email_verified: boolean
  }
```

Platform account records may be created by assigning a random universally unique identifier (“UUID”) and adding it to a platform accounts table of a database associated with the transaction processing system. As described, the endpoints discussed herein may be served from a dedicated address accessible by, for example, browsers and other applications executing on the user device of a customer and by merchant platform systems. The dedicated address points to the appropriate API endpoints on the backend, enabling the exact location of the API endpoints to be configured dynamically, by adjusting the pointer, so long as the dedicated address remains.

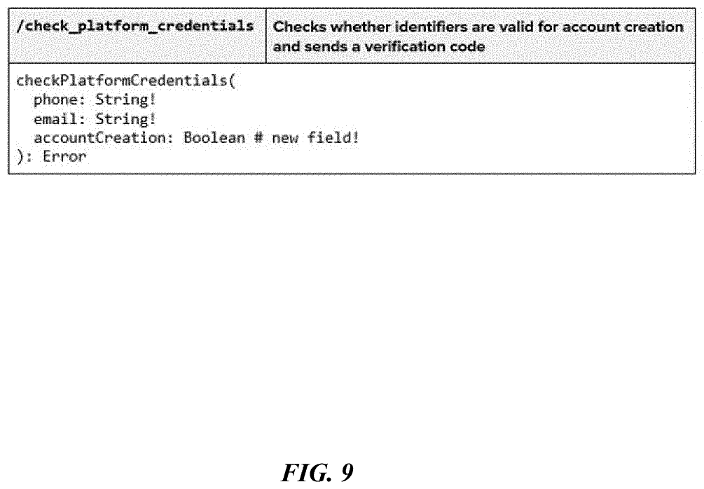

An endpoint may also be created to handle open registration. The endpoints can be configured to conditionally validate that an email address and phone number submitted during registration (e.g., by an application executing on a user device or on behalf of a user by a transaction processing system) are not associated with an existing transaction processing system account. The endpoints can be further configured to send a dynamic code (e.g., a one-time use password) to either the phone or email. The system can look up the user, e.g., customer, associated with this code by joining data tables in the database associated with the transaction processing system storing email addresses and phone numbers of customer accounts using the phone and email being used to create an account. This prevents attackers from reserving email/phone number combinations and otherwise prevents the use of the email and phone number of the customer for its intended purpose. If the code validation succeeds, a user_login_identifiers record is created. The endpoints may be protected by IP address and session rate limits, which protect from basic brute force attacks to send SMS messages to random phone numbers. An example check_platform_credentials endpoint is illustrated in FIG. 9. Additional endpoints can be customized for different ecommerce platforms.

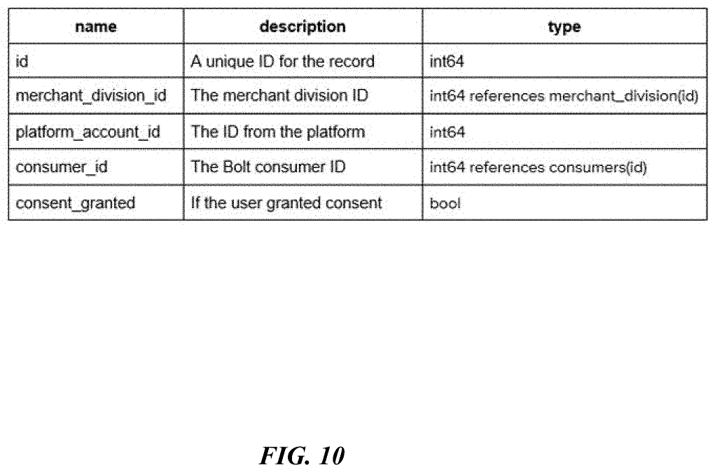

FIG. 10 illustrates an example schema for platform accounts. The schema provides for data that may be included within a platform account record stored by the transaction processing system (e.g., with a data table of the database associated with the transaction processing system). As described herein, the platform account record can be stored in a database of the transaction processing system. The schema can include, for example, a unique identifier for the record itself to allow for unique indexing of the database. This identifier can be, for example, a UUID as described herein. The schema can include, for example, a merchant identifier or merchant division identifier if there are multiple divisions of a given merchant that have their own credential authentication procedures. The schema can include, for example, an identifier for the customer on the merchant's login platform. The schema can include, for example, an identifier for the customer or user of the transaction processing system. This identifier can be provided by the customer when they are signing up for a transaction processing system account. The schema can further include a Boolean value or flag indicating whether the customer provided authorization or consent to link the customer's account with the transaction processing system and the merchant platform and allow the customer to log into the merchant platform using the transaction processing system.

Particular embodiments disclosed herein may be implemented using one or more example architectures described herein. Underlying foundational concepts and terms of art relied upon may relate to one or more of the following. A transaction processing system, of which the “Bolt Platform” is an example, can consist of four conceptual parts. The frontend that serves both the main consumer checkout flow as well as internal and external dashboards and administrative tools. The core services that power the checkout flow as well as fraud detection and payments. Bolt is architected as a set of independent services which communicate to each other via HyperText Transfer Protocol Representational State Transfer (“HTTP REST”) or AMAZON Web Services Simple Queue Service (“AWS SQS”) messages. The Bolt Application Programming Interface (“Bolt API”), which is the primary means by which merchant systems interface with Bolt, exposed to the outside world via HTTPS REST. Plugins, which are deployed to merchant systems and which connect these systems with the Bolt API.

Other foundational concepts and terms of art may relate to one or more of the following:
Processor integrations to automate chargeback handling (syncing, representment)
A regression model to predict the chance of winning a representment. From the regression model the system may derive the expected value.
A classification model to recommend action items to the merchant. Example action items including fighting chargebacks or not or what is the most valuable evidence.
Merchant integration to potentially generate evidence automatically. Evidence may include:
   AVS results
   CVV results
   Billing/shipping addresses
   Historical orders
   Shipment receipt
   Tracking details
   Third party data on the customer

In all example embodiments described herein, appropriate options, features, and system components may be provided to enable collection, storing, transmission, information security measures (e.g., encryption, authentication/authorization mechanisms), anonymization, pseudonymization, isolation, and aggregation of information in compliance with applicable laws, regulations, and rules. In all example embodiments described herein, appropriate options, features, and system components may be provided to enable protection of privacy for a specific individual, including by way of example and not limitation, generating a report regarding what personal information is being or has been collected and how it is being or will be used, enabling deletion or erasure of any personal information collected, and/or enabling control over the purpose for which any personal information collected is used.

The frontend of the Bolt Platform is stored in a monorepo. It consists of the following sub-components:
“Connect.js”—renders the Bolt checkout button and bootstrap iframe for checkout
“checkout”—which is the customer-facing component for checkout experience
“Merchant”—which is the merchant facing dashboard
“Admin”—which is the internal dashboard used by risk analysts, merchant success, and engineering

The core services and the APIs are stored in a monorepo. Examples of services include:
“API”—which is the set of APIs that power the checkout flow
“adminapi”—which is the set of APIs that power the admin dashboard.
“apihooks”—which sends webhook messages to merchant's shopping platforms
“AsyncJobs”—which is the job framework to handle long-running asynchronous operations
“Notifier”—which sends notifications such as emails and short message service (“SMS”) messages
“Imageproxy”—which is a lightweight proxy to serve images

Backend services may be written in go (with some machine-learning (“ML”) logic in python used for risk modeling). Frontend components may be written in React/Typescript. Data may be stored in Postgres, hosted by a relational database service (RDS). Another database used for state management may be Redis.

“Tokenizer” is a completely separate service, available in a serverless way to handle card tokenization. Tokenizer may be maintained completely separate do payment card industry security standards. Tokenizer may be made available in a serverless way, for example, through a service such as AMAZON Lambda. The tokenizer may be implemented in Typescript, powered by a postgres DB. All of the tokenizer infrastructure may be maintained by a separate provider account, with access restricted to a few people.

Below are more details about key services and technology components.

| Service/Component | Purpose/Functionality | Frameworks/Languages |
|---|---|---|
| API | All communication with third-party | Golang |
| | services, front end code, business logic | |
| Connect.js and | Connect.js used for rendering checkout | React |
| iFrame | button, the entry point for shoppers. | Typescript |
| | IFrame is how the checkout form is | Webpack |
| | hosted, secure communication with API | |
| Checkout Frontend | Components used to collect customer | React |
| | information during checkout | Redux |
| | | Webpack |
| | | Typescript |
| Notifier | Microservice for enqueueing and | Golang |
| | sending email and SMS notifications to | SQS |
| | consumers and merchants. | MAILGUN |
| | | TWILIO |
| Account.js and | Used to render the Bolt order tracking | React |
| iFrame | button and SSO login/register button, | Redux |
| | entry point for shoppers | Webpack |
| | The iFrame is used to display the | Typescript |
| | login/register form as well as the Bolt | |
| | account dashboard | |
| Consumer | Components used to display various | React |
| Frontend | features such as the Shopper Dashboard | Redux |
| | and the SSO login flow | Webpack |
| | | Typescript |
| Asynchronous | Heavy lifting of job logic to perform | Golang |
| jobs | tasks like funding, risk review, etc. | Redis |
| | | Machinery |
| Apihooks (i.e | Microservice for enqueueing and | Golang |
| Webhooks) | sending webhook events to merchant | SQS |
| | platforms. | |
| Payment jobs | Scheduler for Asyncjobs framework | Golang |
| | | Machinery |
| | | Redis |
| Search | Service to index transactions for | Golang |
| | merchant dashboard | Elastic Search |
| Tokenizer | PCI compliant serverless lambda to store | Node.js |
| | credit card information. Used to proxy | AWS Lambda |
| | information to 3rd parties | AWS Key Management |
| | | Service (“KWS”) |
| | | AWS RDS |
| Gatekeeper/A/B | Experimentation and feature rollout | Typescript |
| experimentation | platform | AWS Simple Storage |
| | | Service (“S3”) |
| | | AWS CLOUDFRONT |
| Sleet | Provides a standardized wrapper for | Golang |
| | implementing many payment processor | |
| | gateways. | |
| Risk pipeline | Modeling training and model serving | Golang |
| | | Python |
| | | SAGEMAKER |
| Track.js and | Used to track customer behavior when | Typescript |
| iFrame | they land on a merchant’s page. Used | React |
| | for risk signals | |
| Ledger | Double write bookkeeping service for | Golang |
| | funds. Tracks money movements | |
| | through the system | |
| Chargeback | Automated system to pull chargeback | Golang |
| management | information from various payment | React |
| | processors and display to merchants in | Typescript |
| | the merchant dashboard chargeback | |
| | portal | |
| Reporting and | Reports pulled from Vantiv and | Golang |
| Reconciliation | asyncjobs with the ledger to ensure fee | Asyncjobs |
| | collection | AWS S3 |
| Merchant | Centralized dashboard for all actions and | GraphQL |
| Dashboard | reporting related to a merchant’s | React |
| | management of their Bolt system. | Typescript |
| Admin | Centralized dashboard for all internal | GraphQL |
| Dashboard | actions related to managing Bolt | React |
| | merchants. | JavaScript |
| Admin API | API for actions done by Bolt internal | Goland |
| | employees (onboarding merchants, | GraphQL |
| | turning on features) and majority of use | |
| | is for risk review | |

Integration with ecommerce platforms is supported in two ways. First, directly via the API. Second, with plugins deployed to the host instance.

Database: Data is stored in highly available postgres databases backed by AWS RDS. Databases can scale their components within available limits for disk (up to 16 TB), CPU/ram/network (db.xle.32xlarge which is 64 cpu and 3,904 TB RAM).

Messaging: Both Consumer and Merchant-facing components do messaging through our Notifier Service.

Data Access: Services communicate via REST. GraphQL is used pervasively for all non-external endpoints.

Data Warehouse: A cloud data warehousing service may service as the main data warehouse that stores the refined data. AMAZON ELASTIC MAPREDUCE may be used for extract, transform, load (“ETL”) workflows and general analysis of the raw data. AWS Step functions, triggered by a cloud watch event, and AWS Lambda may be used to run the ETL workflows. Results may be loaded into the data warehouse. Code such as ETL scripts may be separately managed. Data consumers (e.g. analysts who look at checkout events) may use plugins to run queries.

Hosting model: The systems may run on highly available containerized backend services backed, for example, by DOCKER and KUBERNETES on AWS. The backend services may be scaled up/down with zero downtime. Infrastructure for serving the frontend code is highly available and backed by AWS. Frontend serving automatically scales with traffic load.

Logging: Frontend (Bolt checkout modal) logs are sent to an error monitoring and reporting tool. All backend applications (e.g., api, paymentjobs, asyncjobs, notifier, etc.) and infrastructure logs (e.g., kubernetes, AWS) are sent to a cloud monitoring platform. Logs may be archived for long-term storage.

Monitoring: High and low level monitors exist to notify engineers of issues. Monitors are replicated to non-production environments to ensure issues can be caught before they make it to production. Monitors are managed in code to ensure consistency and to track changes. Overall application service-level agreements (SLAs) are measured, and lower level monitoring of metrics and logs may be performed using a cloud monitoring platform.

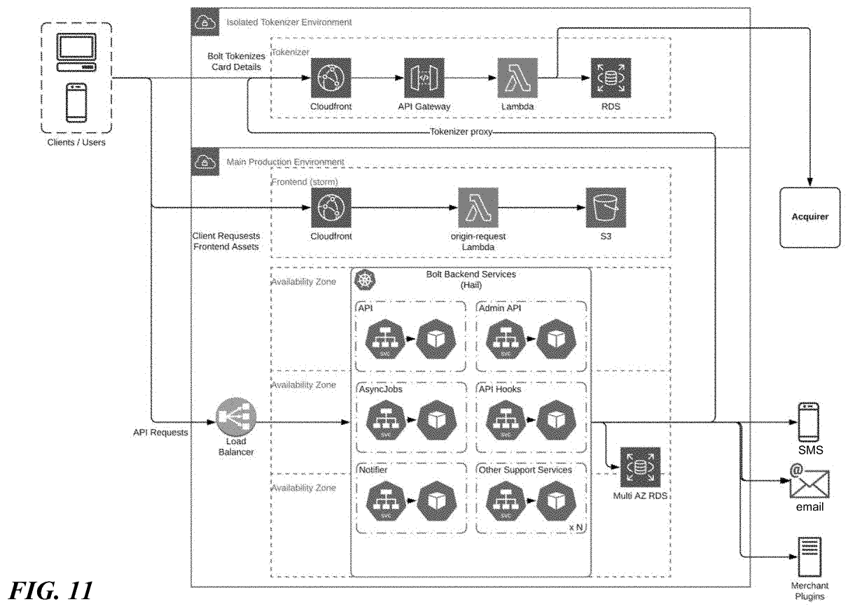

FIG. 11 highlights the physical architecture of the platform.

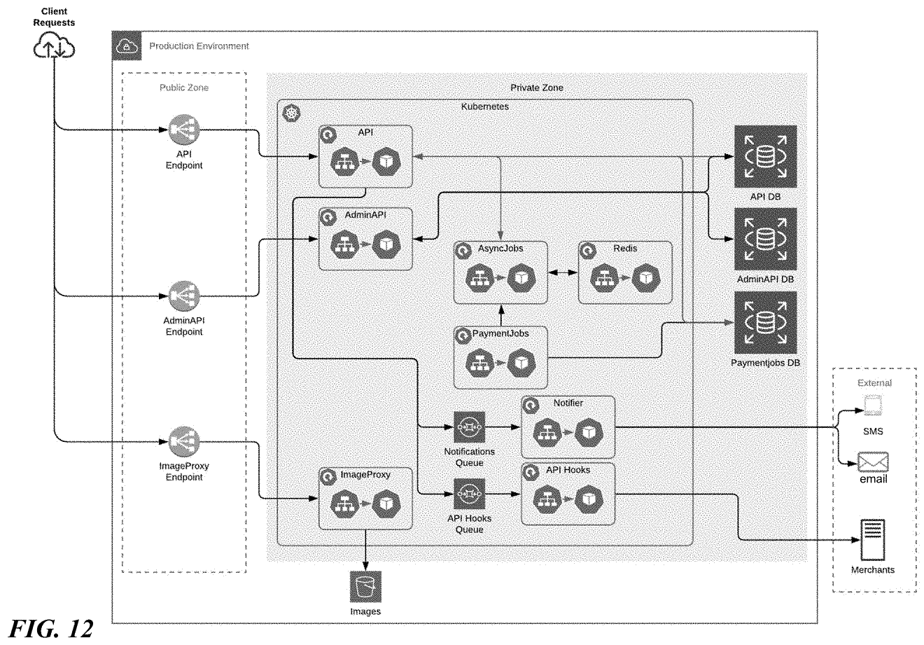

FIG. 12 shows an alternate visualization of the platform, focusing on backend services.

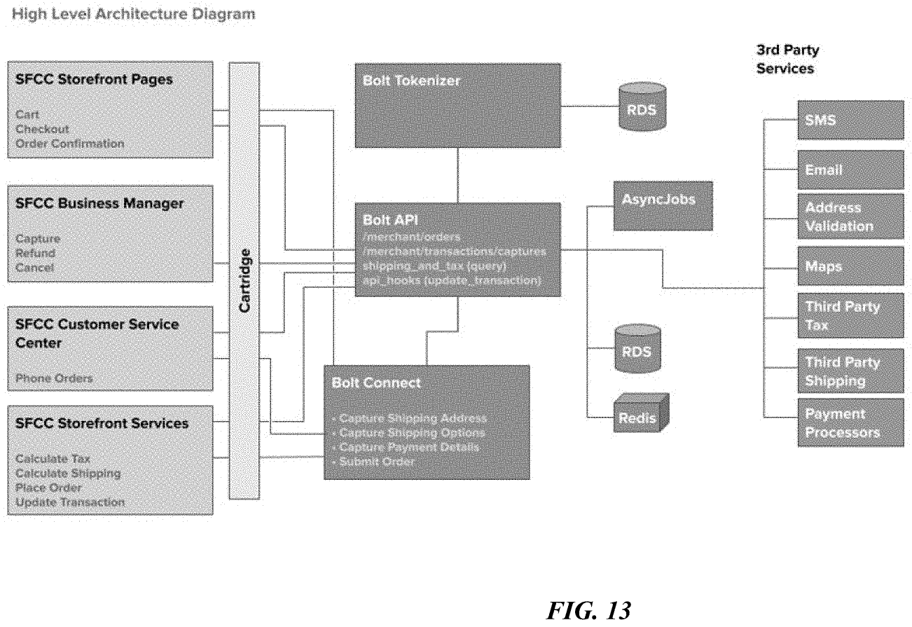

FIG. 13 is helpful in understanding how the platform connects with a third party ecommerce platform.

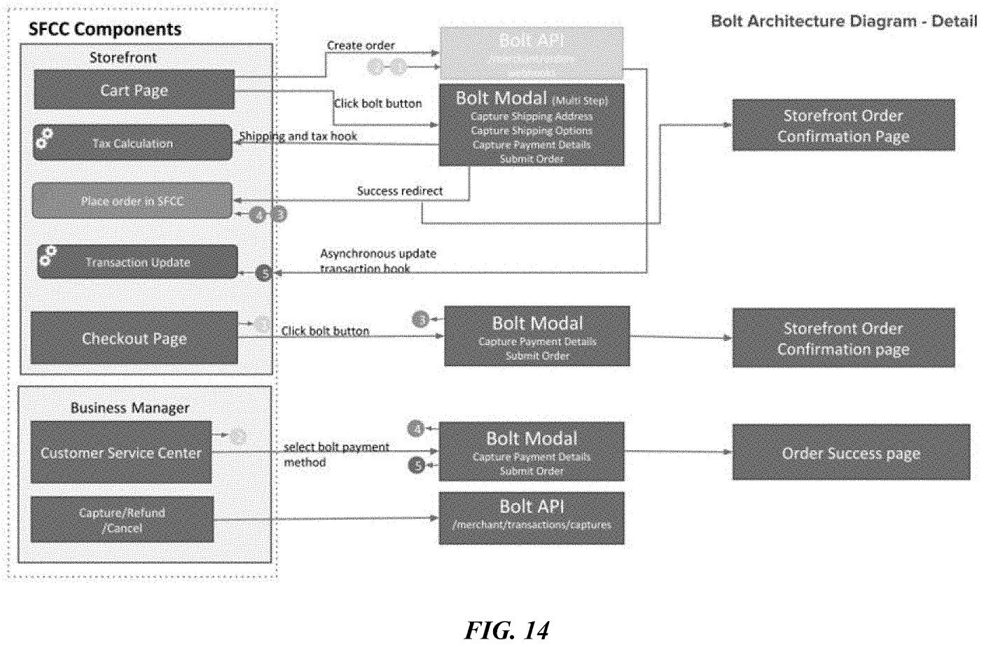

FIG. 14 dives a layer deeper and illustrates the information flows between the platform and a third party platform.

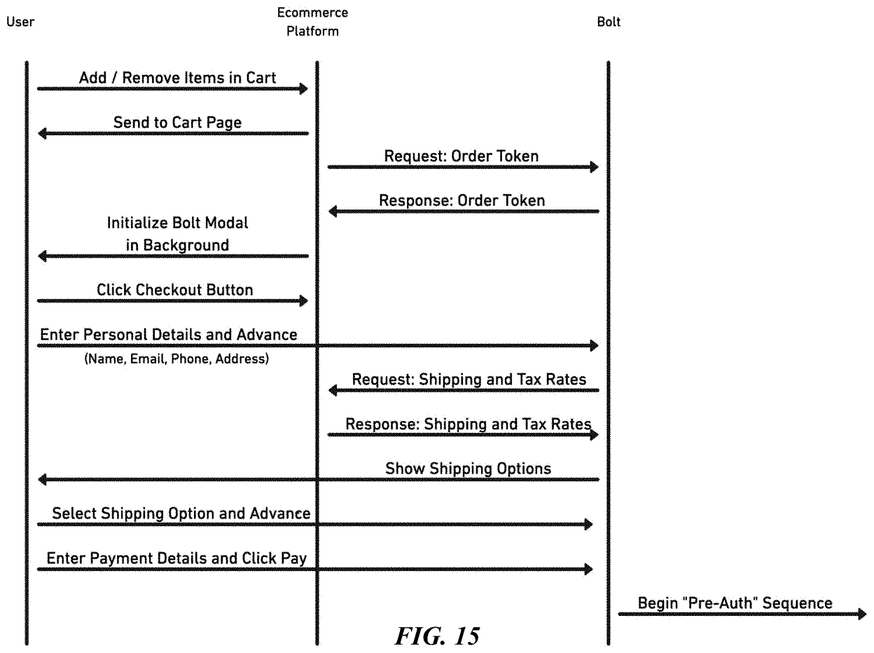

FIG. 15 illustrates the lifecycle of a purchase order.

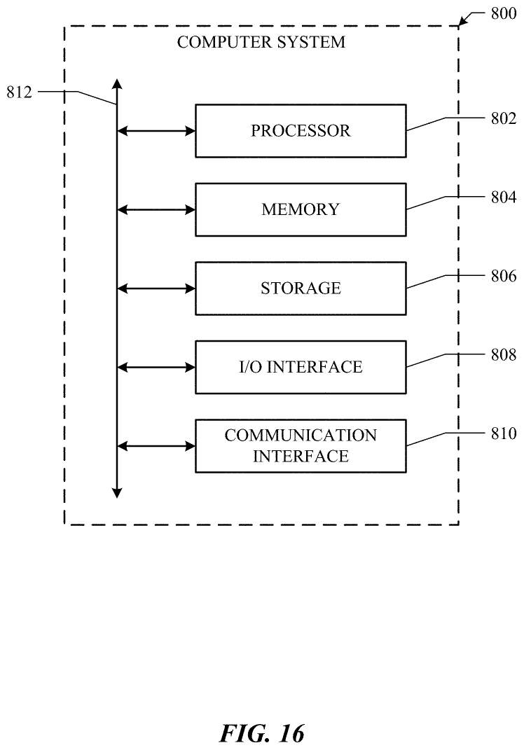

FIG. 16 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800 ) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, any reference herein to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, by a transaction processing system, a request to access a customer account associated with the transaction processing system, the request including a user identifier;
determining, by the transaction processing system, that the user identifier is associated with an account record for a customer stored in a database associated with the transaction processing system;
verifying, by the transaction processing system, authorization to access the customer account associated with the transaction processing system by sending a confirmation code via a communication channel associated with the user identifier; and
coordinating, by the transaction processing system, with a merchant account platform system to associate the customer account associated with the transaction processing system with a customer account associated with a merchant.

2. The method of claim 1, wherein the request to access the customer account associated with the transaction processing system is received with a checkout request associated with the merchant, the method further comprising:
retrieving, by the transaction processing system, payment information for the customer from the account record stored in the database associated with the transaction processing system; and
placing, by the transaction processing system, an order on behalf of the customer with the merchant using the retrieved payment information.

3. The method of claim 2, further comprising:
causing, by the transaction processing system, the retrieved payment information for the customer to be presented in a user interface of a user device associated with the customer, the user interface further comprising an interactive element corresponding to consent to place the order; and
prior to placing the order on behalf of the customer, receiving an indication from the user device that the customer has selected the interactive element corresponding to consent to place the order.

4. The method of claim 1, wherein coordinating with the merchant account platform system to associate the customer account associated with the transaction processing system with the customer account associated with the merchant comprises:
receiving, by the transaction processing system from the merchant account platform system, an indication that the user identifier is not associated with any customer account associated with the merchant;
providing, by the transaction processing system to the merchant account platform system, information from the account record for the customer stored in the database associated with the transaction processing system, wherein the merchant account platform system creates the customer account associated with the merchant using the provided information from the account record for the customer; and
receiving, by the transaction processing system from the merchant account platform system, a confirmation that the user identifier has been associated with the customer account associated with the merchant.

5. The method of claim 1, wherein coordinating with the merchant account platform system to associate the customer account associated with the transaction processing system with the customer account associated with the merchant comprises:
receiving, by the transaction processing system from the merchant account platform system, an indication that the user identifier is associated with the customer account associated with the merchant, wherein the customer account associated with the merchant is further associated with a second user identifier;
verifying, by the transaction processing system, authorization to access the customer account associated with the merchant by sending a confirmation code via a second communication channel associated with the second user identifier; and
receiving, by the transaction processing system from the merchant account platform system, a confirmation that the user identifier has been associated with the customer account associated with the merchant.

6. The method of claim 1, wherein the confirmation code is a dynamically-generated authentication code; and
verifying authorization to access the customer account comprises:
causing, by the transaction processing system, an account authentication user interface to be presented on a user device associated with the customer;
receiving, by the transaction processing system via the account authentication user interface, a response code; and
determining, by the transaction processing system, that the dynamically-generated authentication code corresponds to the response code.

7. The method of claim 6, wherein the user identifier is an email or phone number.

8. The method of claim 1, further comprising:
receiving, by the transaction processing system from the merchant account platform system, a login request to access the customer account associated with the merchant;
verifying, by the transaction processing system, authorization to access the customer account associated with the merchant by sending a confirmation code via a communication channel associated with the user identifier associated with the account record for the customer stored in the database associated with the transaction processing system; and
sending, by the transaction processing system to the merchant account platform system, confirmation corresponding to the login request.

9. A method comprising:
receiving, by a transaction processing system, a request to access a customer account of a customer associated with a merchant, the request including a user identifier;
determining, by the transaction processing system, that the user identifier is not associated with an account record for a customer stored in a database associated with the transaction processing system;
receiving, by the transaction processing system from the customer, consent to create a customer account of the customer associated with the transaction processing system;
verifying, by the transaction processing system, authorization to access the customer account associated with the merchant by sending a confirmation code via a communication channel associated with the user identifier; and
storing, by the transaction processing system, the user identifier in association with an account record for the customer in the database associated with the transaction processing system, the account record for the customer comprising a reference to the customer account of the customer associated with the merchant.

10. The method of claim 9, further comprising:
receiving, by the transaction processing system from the customer, information to store in the account record for the customer, the information comprising biographical information of the customer, payment information of the customer, and shipping preferences of the customer; and
storing, by the transaction processing system, the received information in the account record for the customer in association with the user identifier and the reference to the customer account of the customer associated with the merchant.

11. The method of claim 10, further comprising, subsequent to storing the user identifier in association with an account record for the customer in the database associated with the transaction processing system:
receiving, by the transaction processing system, a checkout request associated with the merchant, the checkout request comprising the user identifier;
retrieving, by the transaction processing system, the payment information for the customer from the account record for the customer using the user identifier;
causing, by the transaction processing system, the retrieved payment information for the customer to be presented in a user interface of a user device associated with the customer, the user interface further comprising an interactive element corresponding to consent to place an order; and
prior to placing the order on behalf of the customer, receiving an indication from the user device that the customer has selected the interactive element corresponding to consent to place the order.

12. The method of claim 9, wherein the request to access the customer account associated with the merchant is received via a user device of the customer.

13. The method of claim 9, wherein the request to access the customer account associated with the merchant is received via a merchant account platform system associated with the merchant.

14. The method of claim 9, wherein the request to access the customer account associated with the merchant is received with a checkout request associated with the merchant, the method further comprising:
receiving, by the transaction processing system, payment information for the customer;
placing, by the transaction processing system, an order on behalf of the customer with the merchant using the received payment information; and
updating the account record of the customer by storing the payment information for the customer in the account record for the customer stored in the database associated with the transaction processing system.

15. The method of claim 9, wherein the request to access the customer account of the customer associated with the merchant further includes an indication that the user identifier is not associated with any customer account associated with the merchant; the method further comprising:
providing, by the transaction processing system to a merchant account platform system of the merchant, information from the account record for the customer, wherein the merchant account platform system creates the customer account associated with the merchant using the provided information from the account record for the customer; and
receiving, by the transaction processing system from the merchant account platform system, a confirmation that the user identifier has been associated with the customer account associated with the merchant.

16. The method of claim 9, wherein the request to access the customer account of the customer associated with the merchant further includes an indication that the user identifier is associated with the customer account associated with the merchant; the method further comprising:
retrieving, by the transaction processing system from a merchant account platform system of the merchant, information corresponding to the user identifier and the customer account associated with the merchant; and
performing, by the transaction processing system, an operation comprising:
updating the account record for the customer stored in the database associated with the transaction processing system based on the retrieved information corresponding to the user identifier and the customer account associated with the merchant retrieved from the merchant account platform system; or
providing, to the merchant account platform system, information from the account record for the customer stored in the database associated with the transaction processing system to update the information corresponding to the user identifier and the customer account associated with the merchant.

17. The method of claim 9, wherein the confirmation code is a dynamically-generated authentication code; and
verifying authorization to access the customer account associated with the merchant comprises:
causing, by the transaction processing system, an account authentication user interface to be presented on a user device associated with the customer;
receiving, by the transaction processing system via the account authentication user interface, a response code; and
determining, by the transaction processing system, that the dynamically-generated authentication code corresponds to the response code.

18. The method of claim 17, wherein the user identifier is an email or phone number.

19. A method comprising:
receiving, by a transaction processing system, a request to access a customer account of a customer associated with a merchant, the request including a user identifier;
determining, by the transaction processing system, that the user identifier is associated with an account record for a customer stored in a database associated with the transaction processing system, the account record for the customer corresponding to an existing customer account associated with the transaction processing system and referencing the customer account associated with the merchant;
verifying, by the transaction processing system, authorization to access the customer account associated with the merchant by sending a confirmation code via a communication channel associated with the account record for the customer; and
sending, by the transaction processing system to a merchant account platform system of the merchant, confirmation of authorization to access the customer account of the customer associated with the merchant.

20. The method of claim 19, wherein the request to access the customer account of the customer associated with the merchant is received with a checkout request associated with the merchant, the method further comprising:
retrieving, by the transaction processing system, payment information for the customer from the account record stored in the database associated with the transaction processing system; and
placing, by the transaction processing system, an order on behalf of the customer with the merchant using the retrieved payment information.
